(19) United States
(12) Patent Application Publication
(10) Pub. No.: US 2024/0424869 A1
(43) Pub. Date: Dec. 26, 2024

(54) WINDSHIELD FOR VEHICLE AND ITS MANUFACTURING METHOD

(71) Applicant: AGC Inc., Tokyo (JP)

(72) Inventor: Yuukou MINAMIYA, Tokyo (JP)

(73) Assignee: AGC Inc., Tokyo (JP)

(21) Appl. No.: 18/746,735

(22) Filed: Jun. 18, 2024

(30) Foreign Application Priority Data
Jun. 20, 2023 (JP) 2023-101147

(51) Int. Cl. B60J 1/02; C03B 23/203; H05B 3/86

(52) U.S. Cl. CPC B60J 1/02; C03B 23/203; H05B 3/86

(57) ABSTRACT

A windshield for vehicle includes a laminated glass in which a first glass plate and a second glass plate are bonded together with an intermediate film interposed therebetween, in which the laminated glass includes a glass plate with a terminal including the second glass plate, a conductor, and the terminal, the conductor including a terminal joint portion, and the terminal being joined to the terminal joint portion of the conductor through lead-free solder; the conductor includes a feeding portion for feeding electricity to an electric function portion, and the feeding portion includes the terminal joint portion; the glass plate with the terminal includes a light-shielding layer between the second glass plate and at least a part of the conductor including the feeding portion; and a porosity of at least a forming region of the feeding portion in the light-shielding layer is 12% or lower.

### INCORPORATION BY REFERENCE

This application is based upon and claims the benefit of priority from Japanese patent application No. 2023-101147, filed on Jun. 20, 2023, the disclosure of which is incorporated herein in its entirety by reference.

### BACKGROUND

The present disclosure relates to a windshield for vehicle and its manufacturing method.

A laminated glass in which a plurality of glass plates are bonded together or a tempered glass is suitably used for a window glass for vehicle such as an automotive. In general, a glass plate that is used as a material for a windshield for vehicle is formed into a shape having a curved surface by thermoforming, and a light-shielding layer is formed in the peripheral region of the glass plate.

A windshield for vehicle including a conductor that includes or is connected to an electric function portion, and a feeding member such as a harness or a cable has been known. Examples of electric function portions include an electric heating line, an electric heating layer, an antenna, a dimming layer, a light-emitting element, and a combination thereof.

In this specification, a glass plate including a conductor is referred to as a “glass plate with a conductor”.

The light-shielding layer can be formed, for example, by applying a ceramic paste containing a black pigment and glass frit to the glass plate and firing the applied ceramic paste. The conductor can be formed, for example, by applying a silver-containing paste containing a silver powder and glass frit to the glass plate and firing the applied silver-containing paste. The firing of the ceramic paste or the silver-containing paste can be performed simultaneously with the thermoforming of the glass plate.

Further, there are cases where an optical apparatus including an optical device that acquires information about an area ahead of a vehicle, such as an ADAS (Advanced Driver Assistance systems) camera, LiDAR (Light Detection And Ranging), a radar, and an optical sensor, and a housing called a bracket or the like that houses the optical device is mounted on the inner surface of a windshield in order to perform automatic driving and/or to prevent a collision. In such a configuration, in order to improve the accuracy of the sensing by the optical apparatus, in some cases, an electric heating line for preventing condensation and frost from being formed is formed in a part of the glass located in front of the optical device.

The above-described glass plate with a conductor to which such an optical apparatus is attached may include, in a plan view, an optical apparatus mounting region in which the optical apparatus is mounted, a light-transmitting portion which is located inside the optical apparatus mounting region and through which external incident light entering the optical apparatus and/or outgoing light exiting from the optical apparatus passes, and a light-shielding layer which surrounds at least a part of the light-transmitting portion.

The above-described conductor for an optical apparatus may include an electric heating line formed inside the light-transmitting portion, a feeding portion formed outside the light-transmitting portion and composed of a pair of feeding electrodes (also referred to as a pair of busbars), and a connection line formed outside the light-transmitting portion and connecting the electric heating line with the feeding portion. A feeding member such as a harness or a cable is joined to each of the feeding electrodes.

In the above-described conductor for an optical apparatus, the electric heating line formed inside the light-transmitting portion is designed so as to be narrow so that it is less likely to be visually recognized by people outside the vehicle and does not affect the acquisition of information about an area ahead of the vehicle by the optical apparatus through the light-transmitting portion. Meanwhile, the feeding portion is designed so as to be wider than the electric heating line because its purpose is not to generate heat, and it requires a region for joining the feeding member. Therefore, the feeding portion is typically formed on the light-shielding layer so that it is not visible to people outside the vehicle.

In the related art, the joining between the feeding portion and the feeding member is carried out by using solder.

For example, a terminal is fixed to the tip of the feeding member such as a wire harness, and this terminal is joined to the feeding portion included in the conductor by using solder. Examples of solder include leaded solder and lead-free solder. In recent years, there is concern about the effect of lead on the environmental and legal restrictions on leaded solder are spreading, so it is desired to use lead-free solder.

Each of Japanese Unexamined Patent Application Publication No. 2021-18932 and International Patent Publication No. WO2022/176814 discloses a window glass for vehicle in which: a light-shielding layer is formed on a laminated glass; a conductor including a plurality of feeding portions is formed on the light-shielding layer; and a terminal is joined to each of the feeding portions through lead-free solder (claims 1, 24, 25 and 30, FIGS. 1, 5 and 6, and the like of Japanese Unexamined Patent Application Publication No. 2021-18932; and claims 1, 11 and 15, FIG. 2, and the like of International Patent Publication No. WO2022/176814).

In general, the melting point of lead-free solder is higher than that of leaded solder, and is, for example, about 220° C., so it is necessary to perform solder joining at a higher temperature (for example, about 300° C.). In a glass plate with a conductor, when a conductor and a terminal are joined to each other by lead-free solder, the glass plate is locally heated to a high temperature and the temperature locally decreases from the high temperature to a normal temperature. When the temperature decreases, due to the difference between the thermal expansion coefficient of the glass plate and that of the lead-free solder, a difference occurs between the amount of the thermal shrinkage of the glass plate and that of the lead-free solder, thus causing a stress (specifically, a tensile stress) in the glass plate with the conductor. Further, in some cases, this stress remains even after the temperature has decreased. This residual stress may cause cracks in the glass plate after the window glass is manufactured. Further, since lead-free solder does not contain lead, which has a low elastic modulus, it has a higher elastic modulus than that of the leaded solder and is less likely to deform than leaded solder is. Therefore, a residual stress that has occurred in the glass plate with the conductor is less likely to be reduced. For these reasons, when a conductor and a terminal are joined to each other by lead-free solder, a problem that a residual stress occurs in the glass plate after the joining and cracks may occur after the manufacturing due to the residual stress could occur.

In this specification, a glass plate including a conductor and a terminal is also referred to as a “glass plate with a terminal”.

When the breaking strength of a glass plate to which terminals have already been attached is low, there is a risk that cracks occur in the glass when an external force is applied to the glass plate. In particular, when terminals are joined to a feeding portion formed on a light-shielding layer by using lead-free solder, the breaking strength of the glass plate to which the terminals have already been attached tends to decrease. It is desirable that the breaking strength of the glass plate to which the terminals have already been attached can be increased in the solder joining using lead-free solder while the conductor is designed so that it is less likely to be visually recognized by people outside the vehicle.

In this specification, “the breaking strength of a glass plate to which terminals have not been attached yet or have already been attached” is expressed by an amount of a load that is applied to the glass plate to which the terminals have not been attached yet or have already been attached at the point when it is broken, and can be measured by a method described in the “Example” section (which will be described later).

The present disclosure has been made in view of the above-described circumstances, and an object thereof is to provide a windshield for vehicle and its manufacturing method, in which: the windshield for vehicle includes a part in which a conductor is joined with a terminal by using lead-free solder; the windshield for vehicle can be designed so that a feeding portion of the conductor is not visible to people outside the vehicle; and a glass plate thereof to which the terminal has been attached has an improved breaking strength.

### SUMMARY

The present disclosure provides a windshield for vehicle and its manufacturing method described in the following items [1] to [12].

[1] A windshield for vehicle comprising a laminated glass in which a first glass plate and a second glass plate are bonded together with an intermediate film interposed therebetween, wherein
the laminated glass comprises a glass plate with a terminal comprising the second glass plate, a conductor, and the terminal, the conductor being formed on a surface of the second glass plate on a side thereof opposite to an intermediate film side thereof, and comprising a terminal joint portion to which the terminal is joined, and the terminal being joined to the terminal joint portion of the conductor through lead-free solder,
the conductor comprises an electric function portion or is electrically connected to an electric function portion, the conductor comprises a feeding portion for feeding electricity to the electric function portion, and the feeding portion comprises the terminal joint portion,
the glass plate with the terminal comprises a light-shielding layer between the second glass plate and at least a part of the conductor comprising the feeding portion, and
a porosity of at least a forming region of the feeding portion in the light-shielding layer is 12% or lower.

[2] The windshield for vehicle described in item [1], wherein the porosity of at least the forming region of the feeding portion in the light-shielding layer is 8% or lower.

[3] The windshield for vehicle described in item [2], wherein the porosity of at least the forming region of the feeding portion in the light-shielding layer is 3% or lower.

[4] The windshield for vehicle described in any one of items [1] to [3], wherein the light-shielding layer contains a black pigment and glass frit.

[5] The windshield for vehicle described in any one of items [1] to [4], wherein the conductor contains silver and glass frit.

[6] The windshield for vehicle described in any one of items [1] to [5], wherein
the glass plate with the terminal comprises, in a plan view, an optical apparatus mounting region and a light-transmitting portion, the optical apparatus mounting region being configured so that an optical apparatus is mounted therein, and the light-transmitting portion being located inside the optical apparatus mounting region and configured so that external incident light entering the optical apparatus and/or outgoing light exiting from the optical apparatus passes therethrough,
the light-shielding layer is formed, in the plan view, so as to surround at least a part of the light-transmitting portion, and
the conductor comprises an electric heating line formed inside the light-transmitting portion, the feeding portion formed outside the light-transmitting portion, and a connection line formed outside the light-transmitting portion and connecting the electric heating line with the feeding portion.

[7] The windshield for vehicle described in item [6], wherein the connection line and the feeding portion are formed on the light-shielding layer in the glass plate with the terminal.

[8] The windshield for vehicle described in any one of items [1] to [7], wherein a feeding member formed of a round lead or a foil lead is fixed to the terminal.

[9] A method for manufacturing a windshield for vehicle described in any one of items [1] to [8], comprising:
a step (X) of preparing a glass plate with a conductor in which the light-shielding layer and the conductor are formed on the surface of the second glass plate;
a step (Y) of bonding the first glass plate with the glass plate with the conductor with the intermediate film interposed therebetween; and a step (Z) of joining the terminal to the terminal joint portion of the conductor through lead-free solder, wherein
the step (X) successively comprises:
a step (S11) of applying a ceramic paste containing a black pigment and glass frit to the surface of the second glass plate, and thereby forming a ceramic paste layer thereon, the black pigment and the glass frit being materials for the light-shielding layer;
a step (S12) of applying a silver-containing paste containing silver and glass frit to the surface of the second glass plate, and thereby forming a silver-containing paste layer thereon, the silver and the glass frit being materials for the conductor; and
a step (S13) of firing the ceramic paste layer and the silver-containing paste layer, and thereby forming the light-shielding layer and the conductor, respectively.

[10] A method for manufacturing a windshield for vehicle described in any one of items [1] to [8], comprising:
a step (X) of preparing a glass plate with a conductor in which the light-shielding layer and the conductor are formed on the surface of the second glass plate;
a step (Y) of bonding the first glass plate with the glass plate with the conductor with the intermediate film interposed therebetween; and a step (Z) of joining the terminal to the terminal joint portion of the conductor through lead-free solder, wherein
the step (X) successively comprises:
a step (S21) of forming the light-shielding layer by applying a ceramic paste containing a black pigment and glass frit to the surface of the second glass plate, and firing the applied ceramic paste; and
a step (S22) of forming the conductor by applying a silver-containing paste containing silver and glass frit to the surface of the second glass plate, and firing the applied silver-containing paste.

[11] The method for manufacturing a windshield for vehicle described in item [9] or [10], wherein a total content of organic components in the ceramic paste is 30 mass % or less.

[12] The method for manufacturing a windshield for vehicle described in any one of items [9] to [11], wherein a total content of polymer components in the ceramic paste is 5 mass % or less.

In the windshield for vehicle according to the present disclosure, at least the feeding portion of the conductor included in the glass plate with the terminal is formed on the light-shielding layer, so that it can be designed so that the feeding portion of the conductor is not visible to people outside the vehicle. By limiting the porosity of at least the forming region of the feeding portion in the light-shielding layer, the breaking strength of the glass plate can be improved both before and after the terminal is attached to the glass plate.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1A is an overall plan view of a windshield for vehicle according to an embodiment of the present disclosure;

FIG. 1B is an overall plan view of a first glass plate;

FIG. 2 is a partially enlarged plan view of FIG. 1A;

FIG. 3 is a cross-sectional diagram taken along a line III-III in FIG. 2;

FIG. 4 is a cross-sectional diagram taken along a line IV-IV in FIG. 2;

FIG. 5 is a cross-sectional diagram taken along a line V-V in FIG. 2;

FIG. 6 is a partially enlarged cross-sectional view of FIG. 5;

FIG. 7A is a process diagram of a method for manufacturing a windshield for vehicle according to an embodiment;

FIG. 7B is a process diagram of a method for manufacturing the windshield for vehicle according to the embodiment;

FIG. 7C is a process diagram of a method for manufacturing the windshield for vehicle according to the above embodiment;

FIG. 8 shows images showing an example of measurement of the porosity of a glass laminate obtained in Example 1;

FIG. 9 shows images showing an example of measurement of the porosity of a glass laminate obtained in Example 2;

FIG. 10 shows images showing an example of measurement of the porosity of a glass laminate obtained in Example 3;

FIG. 11 is a graph showing results of evaluations of glass laminates obtained in Examples 1 to 3; and

FIG. 12 is a graph showing results of evaluations of glass laminates obtained in Examples 1 to 3.

### DESCRIPTION OF EMBODIMENTS

In general, a thin-film structure is referred to as a “film”, “sheet” or the like depending on its thickness. In this specification, they are not clearly distinguished. Therefore, a “film” in this specification may include a “sheet”.

In this specification, term “omitted” affixed to a term expressing a shape means that the shape include partially changed shapes, such as a chamfered shape obtained by rounding the corners of the shape, a shape in which a part is missing (e.g., a part is cut out), and a shape with an arbitrary additional small shape added thereto.

In this specification, a “glass plate” refers to an un-tempered glass unless otherwise specified.

In this specification, the “surface of a glass plate” refers to a major surface having a large area other than the end surfaces (also referred to as sides) of the glass plate unless otherwise specified.

In this specification, “up and down”, “left and right”, “lengthwise and crosswise”, and “inside and outside” (or “inner and outer”) are “up and down”, “left and right”, “lengthwise and crosswise”, and “inside and outside” as viewed from the inside of the vehicle in the state in which the windshield for vehicle is mounted in the vehicle (in the state in which the windshield for vehicle is actually used) unless otherwise specified.

In this specification, “lead-free solder” refers to solder that substantially does not contain lead, and the content of lead in the lead-free solder is 500 ppm or less.

In this specification, the fact that the lead-free solder “substantially does not contain a certain metallic element other than lead” means that the content of this metallic element is 1,000 ppm or less unless otherwise specified.

In this specification, the normal temperature is 20 to 25° C. unless otherwise specified.

In this specification, a “polymer” refers to a component having a molecular weight of 100 or larger unless otherwise specified.

In this specification, a “molecular weight of a polymer” is a standard polystyrene-converted weight-average molecular weight (Mw) or a standard polystyrene-converted number-average molecular weight (Mn) as determined (or measured) by gel permeation chromatography (GPC) unless otherwise specified.

In this specification, when a symbol “-” (or “to”), which indicates a numerical range, is used, it means that a numerical value in front of the symbol and that behind the symbol are included as a lower limit value and an upper limit value, respectively, in the range.

Embodiments according to the present disclosure will be described hereinafter.

### [Windshield for Vehicle]

The present disclosure relates to a windshield for vehicle including a laminated glass in which a first glass plate and a second glass plate are bonded together with an intermediate film interposed therebetween.

The first glass plate may be an exterior-side glass plate, and the second glass plate may be an interior-side glass plate.

The type of the glass plate that is used as the material for the laminated glass is not limited to any particular types, and examples thereof include soda-lime glass, borosilicate glass, aluminosilicate glass, lithium-silicate glass, quartz glass, sapphire glass, and non-alkali glass.

The thickness of the laminated glass is not limited to any particular values, but is preferably 2 to 6 mm when it is used for a windshield for vehicle.

The thicknesses of the interior-side glass plate and the exterior-side glass plate may be the same as each other or different from each other. The thickness of the interior-side glass plate is preferably 0.3 to 2.3 mm. When the thickness of the interior-side glass plate is 0.3 mm or larger, the handling property is satisfactory. Further, when it is 2.3 mm or smaller, it is possible to prevent the mass of the glass plate from becoming too large. The thickness of the exterior-side glass plate is preferably 1.0 to 3.0 mm. When the thickness of the exterior-side glass plate is 1.0 mm or larger, the strength such as the tolerance to stone chips is sufficient. Further, when it is 3.0 mm or smaller, the mass of the laminated glass is not too large, which is preferred in terms of the fuel efficiency of the vehicle. It is preferred that the thicknesses of the exterior-side glass plate and the interior-side glass plate both be 1.8 mm or smaller, because such thicknesses make it possible to achieve a laminated glass reduced in weight and having an improved sound insulating property.

The windshield for vehicle may have, when it is mounted on a vehicle, a curved shape so that it is convex on the exterior side. When the windshield for the vehicle is laminated glass, both the interior-side glass plate and the exterior-side glass plate may have a curved shape such that the outside of the vehicle becomes convex. The windshield for vehicle may have a single curved shape, i.e., a shape that curved in only one of the left/right direction and the up/down direction, or may have a double curved shape, i.e., a shape that is curved in both the left/right direction and the up/down direction. The radius of the curvature of the windshield for vehicle may be 2,000 to 11,000 mm. The radii of the curvatures of the windshield for vehicle in the left/right and up/down directions may be the same as each other or different from each other. For bending the windshield for vehicle into a desired shape, gravity forming, press forming, roller forming, or the like is used.

The laminated glass may include, in at least a part of its surface, a film having a function such as a water repellent function, a low reflection function, a low emission function, an ultraviolet-light blocking function, an infrared-light blocking function, and a coloring function.

The laminated glass may include, in at least a part of the inside thereof, a film having a function such as a low reflection function, a low emission function, an ultraviolet-light blocking function, an infrared-light blocking function, and a coloring function. At least a part of an intermediate film of the laminated glass may have a function such as an ultraviolet-light blocking function, an infrared-light blocking function, and a coloring function.

The intermediate film of the laminated glass may be a single layer film or a laminated film.

In the windshield for vehicle according to the present disclosure, the laminated glass includes a glass plate with a terminal including a second glass plate, a conductor, and the terminal, in which the conductor is formed on a surface of the second glass plate on a side thereof opposite to an intermediate film side thereof, and includes a terminal joint portion to which the terminal is joined, and the terminal is joined to the terminal joint portion of the conductor through lead-free solder.

In this specification, the “terminal joint portion” of the conductor refers to a part of the conductor directly below the lead-free solder.

In the glass plate with the terminal, the above-described conductor includes or is electrically connected to an electric function portion.

Examples of the electric function portion include at least one electric heating line, an electric heating layer, an antenna, a dimming layer, a light-emitting element, and a combination thereof. Examples of the light-emitting element include an LED (Light Emitting Diode) and an OLED (Organic Light Emitting Diode).

It is possible to remove condensation, frost, snow, ice or the like and preventing them from being formed or adhering to the windshield or the like by at least one electric heating line or electric heating layer. At least one electric heating line or electric heating layer can be used, for example, to prevent wipers from being frozen, and to improve the accuracy of the sensing by an optical apparatus including an optical device such as a camera and a radar.

The electric function portion can be manufactured by a known method.

In a glass plate with a terminal, the above-described conductor includes a feeding portion for feeding electricity to the electric function portion. The feeding portion can include a pair of feeding electrodes (also referred to as a pair of busbars), and each of the feeding electrodes can include a terminal joint portion. For example, one of the feeding electrodes is a positive electrode and connected to a power supply or a signal source provided inside the vehicle through a feeding member, and the other feeding electrode is a negative electrode and connected to the vehicle body (the ground) through a feeding member. Note that only one positive feeding electrode may be provided or a plurality of positive feeding electrodes may be provided. Further, only one negative feeding electrode may be provided or a plurality of negative feeding electrodes may be provided.

When a conductor is connected to the electric function portion, the conductor and the electric function portion may be formed on the same glass surface or on different glass surfaces.

The conductor including the terminal joint portion can be formed by applying a silver-containing paste containing a silver powder and glass frit to a glass plate and firing the applied silver-containing paste. Known glass frit can be used as the glass frit contained in the silver-containing paste, and any of those containing Na, Al, Si, P, Zn, Ba, Bi, and the like can be used the metallic element.

A feeding member composed of a round lead or foil lead can be fixed to the terminal. The term “lead” in this specification includes a coated lead in which at least one lead is coated with an insulating material. A coated lead is preferred as the feeding member.

Examples of specific forms of the feeding member include a harness and a cable. The round lead is, for example, a wire harness or the like. Examples of the foil lead include a flat harness and a flexible printed circuit board or the like.

The feeding member includes a conductor-exposed portion, and the terminal is fixed to this conductor-exposed portion. The material of the conductor-exposed portion is not limited to any particular materials, and examples thereof include Cu, Al, Ag, Au, Ti, Sn, Zn, alloys thereof, and combinations thereof. The conductor-exposed portion may be one that is obtained by plating the surface of a main metal with another metal. The conductor-exposed portion may include a thin oxide film on the surface thereof.

The lead-free solder is solder containing little or no lead, and known solder can be used as the lead-free solder. Examples of lead-free solder include: SnAg-based solder containing Sn and Ag; SnAgCu (SAC)-based solder containing Sn, Ag and Cu; SnZnBi-based solder containing Sn, Zn and Bi; SnCu-based solder containing Sn and Cu; SnZnAl-based solder containing Sn, Zn and Al; and In-based solder containing In.

In view of environmental tolerance and the like, as the lead-free solder, for example, SnAg-based lead-free solder containing Sn and Ag and not substantially containing any of Sb, Cu and In is preferred; and SnAgCu (SAC)-based lead-free solder containing Sn, Ag and Cu and not substantially containing any of Sb and In is also preferred.

The melting point of lead-free solder such as SnAg-based solder and SnAgCu-based solder is higher than that of leaded solder, and is, for example, about 220° C. When lead-free solder such as SnAg-based solder or SnAgCu-based solder is used, the solder joining temperature is, for example, about 300° C. The present disclosure is particularly effective when lead-free solder such as SnAg-based solder or SnAgCu-based solder having a high melting point is used.

Preferred embodiments of lead-free solder such as SnAg-based solder and SnAgCu-based solder will be described hereinafter.

The content of Sn in the SnAg-based or SnAgCu-based lead-free solder is not limited to any particular values, and is preferably 95 mass % or more, more preferably 95 to 98.5 mass %, and particularly preferably 96 to 98 mass %. When the content of Sn is 95 mass % or more (the content of Ag is 5 mass % or less), the melting point of the lead-free solder can be comparatively lowered, so that the solder joining temperature can be comparatively lowered and the rise in temperature of the glass plate can be comparatively reduced. As a result, it is possible to suppress the residual stress occurring in the glass plate and thereby to prevent cracks from occurring in the glass plate which would otherwise occur due to the residual stress.

In general, when Sn-based lead-free solder containing no Ag is used, because of the high compatibility of Sn contained in the lead-free solder with Ag contained in the conductor, so-called “silver dissolving”, in which Ag contained in the terminal joint portion of the conductor dissolves into the lead-free solder containing Sn, tends to occur. In this case, there is a risk that the terminal joint portion may be discolored due to alteration, thinning, or the like, resulting in poor appearance.

By using lead-free solder containing Sn and Ag, it is possible to suppress the dissolution of Ag contained in the terminal joint portion of the conductor into the lead-free solder because Sn in the lead-free solder has already formed a compound(s) with Ag. Therefore, it is possible to prevent the terminal joint portion from being discolored and thereby to prevent its appearance from being impaired which would otherwise be caused by the discoloration.

The content of Ag in the lead-free solder is preferably 1.5 to 5 mass % and more preferably 2 to 4 mass %. When the content of Ag is 1.5 mass % or more, the dissolution of Ag contained in the terminal joint portion of the conductor into the lead-free solder can be effectively suppressed, and a satisfactory bonding strength can be achieved. When the content of Ag is 5 mass % or less, the cost of the material of the lead-free solder can be kept low and the melting point of the lead-free solder can be kept relatively low.

The lead-free solder may contain Cu as a metallic element other than Sn and Ag. The content of Cu in the lead-free solder is not limited to any particular values, and is preferably 1 mass % or less and more preferably 0.5 mass % or less.

Examples of the composition of the SnAg-based lead-free solder include Sn: 98 mass % and Ag: 2 mass %. Examples of the composition of the SnAgCu-based lead-free solder include Sn: 96.5 mass %, Ag: 3.0 mass %, and Cu: 0.5 mass %.

In order to reduce the thermal stress in the glass plate that occurs when a terminal is attached thereto, In-based lead-free solder containing In, which is solder having a low melting point, is also preferred.

Examples of In-based lead-free solder include:
SnIn-based lead-free solder containing Sn and In, and not substantially containing any of Sb, Ag and Cu;
SnAgIn-based lead-free solder containing Sn, Ag and In, and not substantially containing any of Sb, Cu, Bi, Ni and Zn;
SnAgInCu-based lead-free solder containing Sn, Ag, In and Cu, and not substantially containing any of Sb, Bi, Ni and Zn;
SnAgInBi-based lead-free solder containing Sn, Ag, In and Bi, and not substantially containing any of Sb, Cu, Ni and Zn; and
SnAgInNiCuZn-based lead-free solder including Sn, Ag, In, Ni, Cu and Zn and not substantially containing any of Sb and Bi.

Since the feeding portion of the conductor included in the glass plate with a terminal is designed so as to be wider than the electric heating line and the connection line, the feeding portion is preferably designed so as not to be visible to people outside the vehicle.

The glass plate with a terminal on which an optical apparatus is mounted includes, in a plan view, an optical apparatus mounting region in which the optical apparatus is mounted, and a light-transmitting portion which is located inside the optical apparatus mounting region and through which external incident light entering the optical apparatus and/or outgoing light exiting from the optical apparatus passes.

In the glass plate with a terminal, the light-shielding layer is formed, in a plan view, so as to surround at least a part of the light-transmitting portion. Further, the conductor includes an electric heating line formed inside the light-transmitting portion, the feeding portion formed outside the light-transmitting portion, and a connection line formed outside the light-transmitting portion and connecting the electric heating line with the feeding portion.

In the above-described conductor for an optical apparatus, the electric heating line formed inside the light-transmitting portion is designed so as to be narrow so that it is less likely to be visually recognized by people outside the vehicle and does not affect the acquisition of information about an area ahead of the vehicle by the optical apparatus through the light-transmitting portion.

In the present disclosure, in the above-described conductor for an optical apparatus, at least the feeding portion is formed on the light-shielding layer and is designed so that the feeding portion of the conductor is not visible people outside the vehicle. The connection line and the feeding portion are preferably formed on the light-shielding layer.

The light-shielding layer can be formed by a known method, for example, by applying a ceramic paste containing a black pigment and glass frit to a predetermined region on the surface of the glass plate, and firing the applied ceramic paste. The thickness of the light-shielding layer is not limited to any particular values, and is, for example, 5 to 20 μm.

Known glass frit can be used as the glass frit contained in the ceramic paste, and any of those containing Na, Al, Si, P, Zn, Ba, Bi, and the like can be used the metallic element.

The ceramic paste can contain at least one type of organic solvent. Examples of organic solvents include a-terpineol, butyl carbitol, butyl carbitol acetate, 2, 2, 4-trimethyl-1, 3-pentanediol monoisobutyrate, 2, 2, 4-trimethyl-1, 3-pentanediol diisobutyrate, ethylene glycol mono-2-ethylhexyl ether, diethylene glycol mono-2-ethylhexyl ether, ethylene glycol monohexyl ether, diethylene glycol monohexyl ether, ethylene glycol monobutyl ether acetate, and diethylene glycol monobutyl ether.

The ceramic paste may contain at least one type of polymer component. Examples of polymer components include ethyl cellulose, acrylic resins, styrene resins, phenol resins, butyral resins, and the like.

According to the research conducted by the inventors of the present application, it has been found that in the process of firing the ceramic paste layer, organic components (specifically, organic solvents, polymeric components, and the like) contained in the ceramic paste layer decompose and volatilize, so that voids are formed in the light-shielding layer.

In the past, when a conductor is formed on a light-shielding layer, the following method is usually used. That is, a ceramic paste layer is formed by applying a ceramic paste to a glass plate and drying the applied ceramic paste. A silver-containing paste layer is formed by applying a silver-containing paste to the formed ceramic paste layer and drying the applied silver-containing paste. Then, these layers are simultaneously fired. In this method, it is considered that since the ceramic paste layer is fired in the state in which it is covered with the silver-containing paste layer, organic components contained in the light-shielding layer or substances that are formed as such organic components are decomposed cannot easily come out from the light-shielding layer, so that voids may be formed.

In general, in the case where a terminal is joined to a feeding portion formed on a light-shielding layer of a glass plate by using lead-free solder, the breaking strength of the glass plate to which the terminal has been attached tends to decrease.

According to the research conducted by the inventors of the present application, it has been found that the higher the porosity of the light-shielding layer is, the more the breaking strength of the glass plate tends to decrease both before and after the terminal is attached. The reason for this tendency is not completely elucidated, but it is inferred as follows. The presence of voids in the light-shielding layer may cause the denseness of the light-shielding layer to decrease or the uniformity of the light-shielding layer to decrease. The presence of voids in the light-shielding layer may also cause cracks to be formed. It is considered that for these reasons, the presence of voids in the light-shielding layer may cause the strength of the light-shielding layer to decrease.

According to the research conducted by the inventors of the present application, it has been found that the lower the porosity of the light-shielding layer is, the more the breaking strength of the glass plate tends to increase both before and after the terminal to attached. In the windshield for vehicle according to the present disclosure, it is possible to increase the breaking strength of the glass plate both before and after the terminal to attached by limiting the porosity of at least the forming region of the feeding portion in the light-shielding layer. The porosity of at least the forming region of the feeding portion in the light-shielding layer is preferably 12% or lower, more preferably 10% or lower, still more preferably 8% or lower, still more preferably 5% or lower, particularly preferably 3% or lower, and most preferably 2% or lower.

The porosity of the light-shielding layer can be measured by a method described in the “Example” section (which will be described later).

Examples of a method for effectively reducing the porosity of the light-shielding layer include a method for limiting the total content of organic components in the ceramic paste, a method for limiting the total content of polymer components in the ceramic paste, a method for limiting the molecular weight of organic components in the ceramic paste, a method for firing the ceramic paste layer before applying the silver-containing paste thereto, and a combination thereof.

The total content of organic components in the ceramic paste is preferably 30 mass % or less, more preferably 25 mass % or less, and particularly preferably 20 mass % or less. The lower limit is not limited to any particular value, and is, for example, 15 mass %.

The total content of polymer components in the ceramic paste is typically 0.5 to 15 mass %. The upper limit is preferably 10 mass % and more preferably 5 mass %. The lower limit is not limited to any particular value, and is, for example, 2 mass %.

### EMBODIMENT

The present disclosure can preferably be applied to a windshield for vehicle on which an optical apparatus is mounted.

A structure of a windshield for vehicle according to an embodiment of the present disclosure will be described with reference to the drawings.

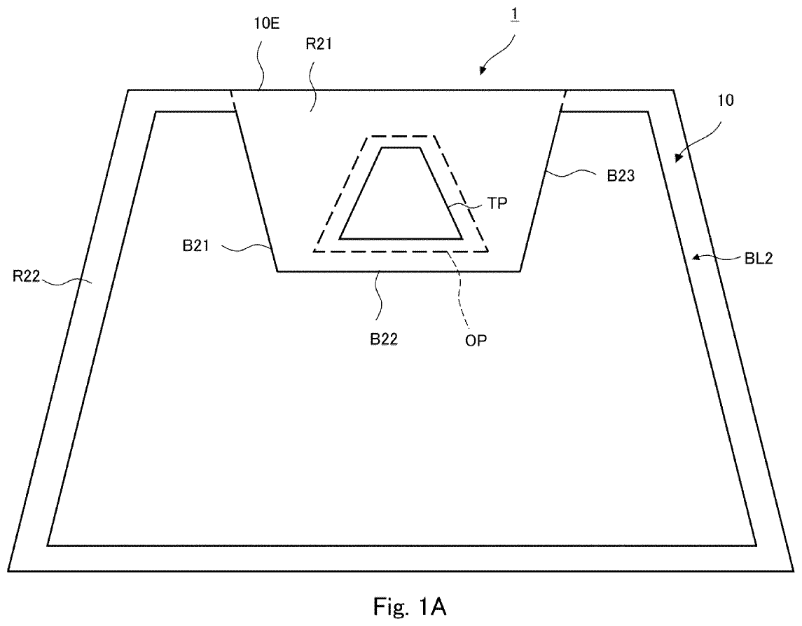

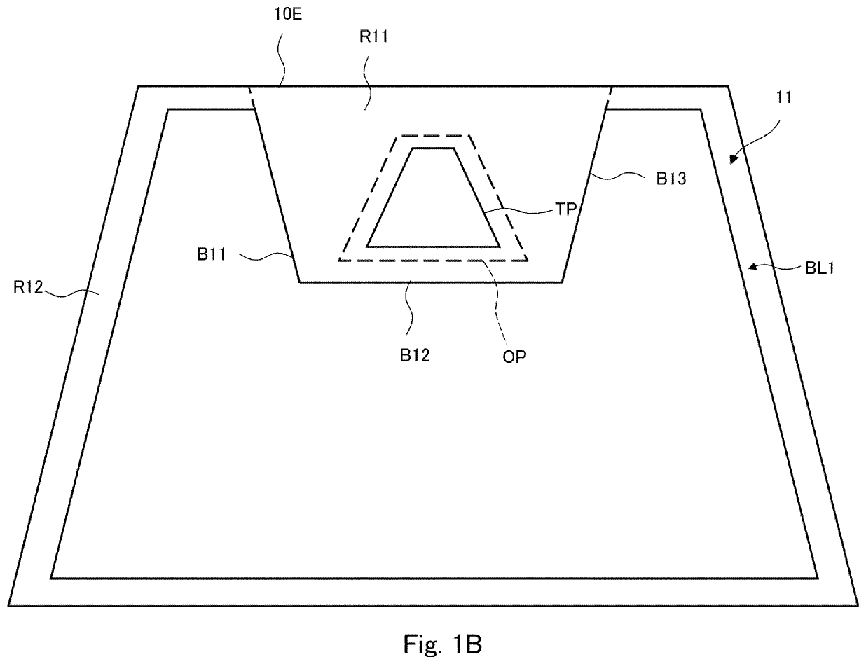

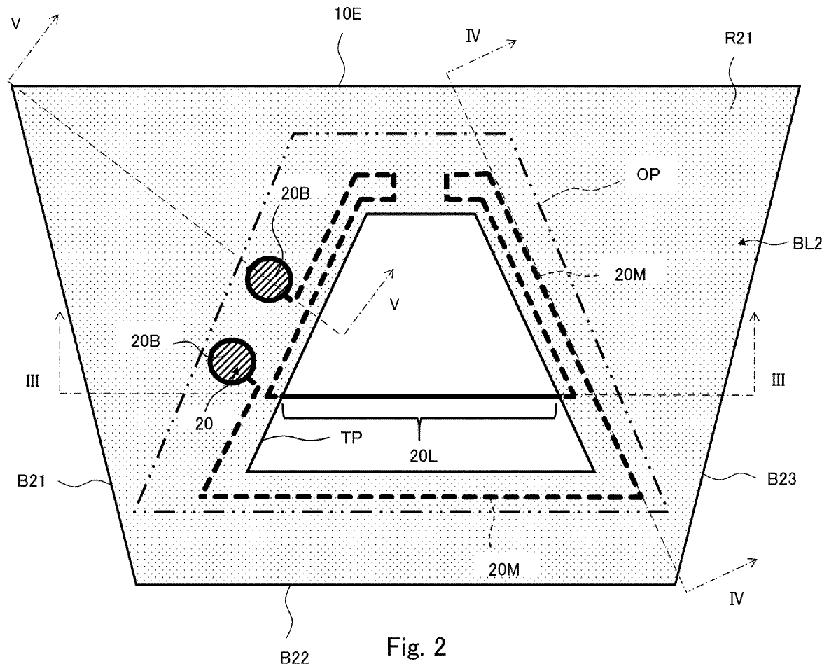

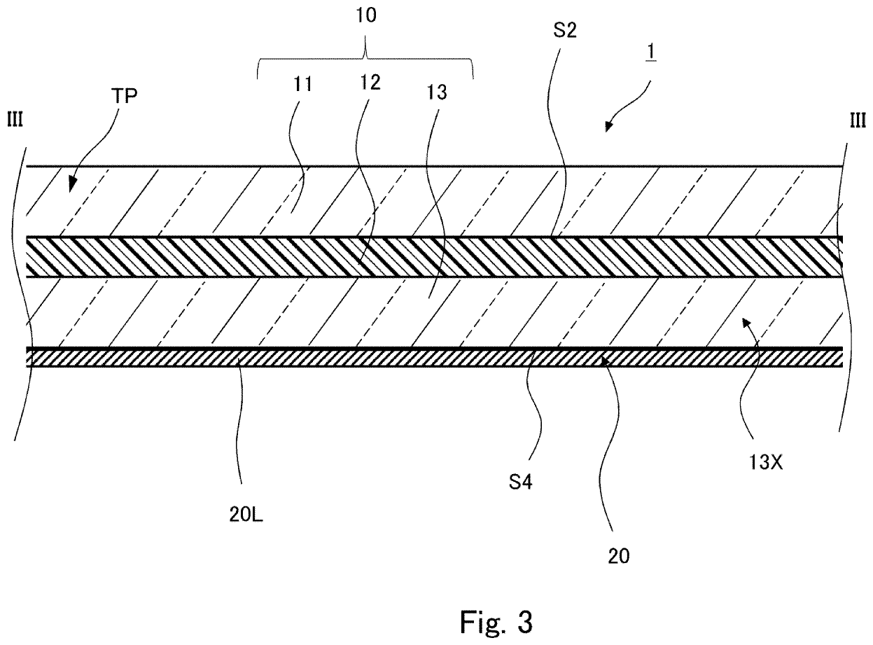

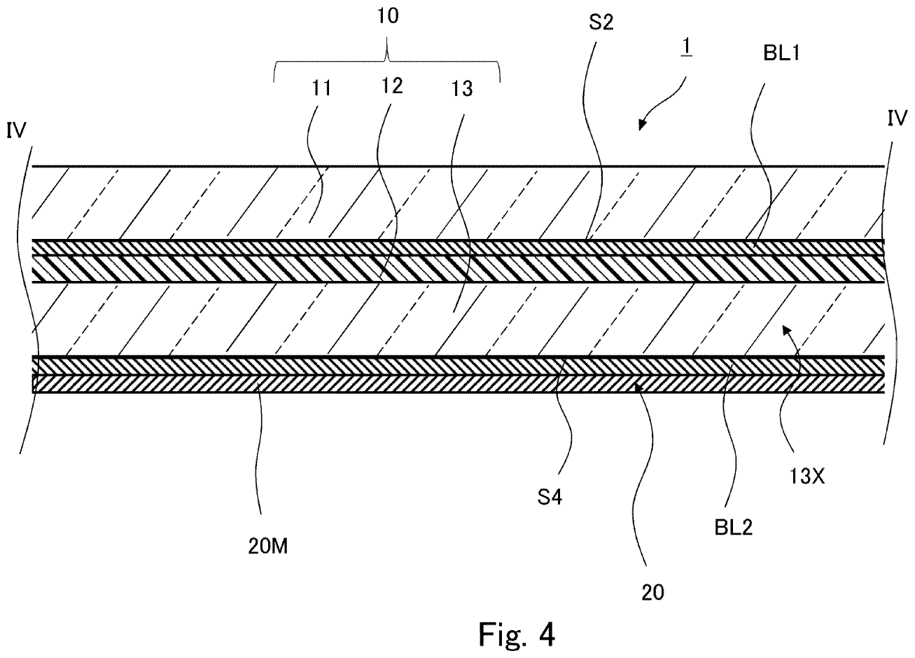

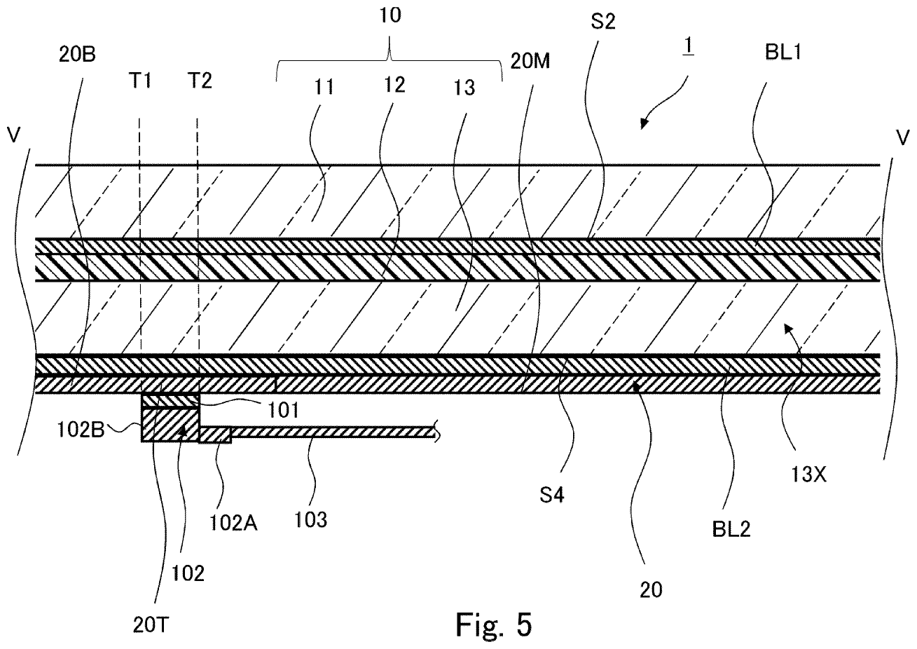

FIG. 1A is an overall plan view of a windshield for vehicle according to this embodiment. FIG. 1B is an overall plan view of a first glass plate. FIG. 2 is a partially enlarged plan view of FIG. 1A. FIGS. 1A and 2 show a state before terminals are joined. In each of FIGS. 1A, 1B and 2, the front side of the drawing is the interior side of the vehicle, and the rear side thereof is the exterior side thereof. FIG. 3 is a cross-sectional diagram taken along a line III-III in FIG. 2. FIG. 4 is a cross-sectional diagram taken along a line IV-IV in FIG. 2. FIG. 5 is a cross-sectional diagram taken along a line V-V in FIG. 2. In each of FIGS. 3 to 5, the upper side of the drawing is the exterior side of the vehicle, and the lower side thereof is the interior side thereof. These drawings are all schematic diagrams, and the scales of components are changed from those of the actual ones on a drawing-by-drawing basis for facilitating the visual recognition of them.

The planar shape of the windshield for vehicle 1 can be designed as desired, and is, for example, a roughly trapezoidal plate-like shape in a plan view in which the plate is curved over the entire length as shown in FIG. 1A.

As shown in FIG. 5, the windshield for vehicle 1 according to this embodiment includes a laminated glass 10 in which a first glass plate 11 and a second glass plate 13 are bonded together with an intermediate film 12 interposed therebetween.

In this embodiment, the laminated glass 10 includes a glass plate with a terminal 13X including: the second glass plate 13; a conductor 20 formed on a surface S4 of the second glass plate 13 on a side thereof opposite to the intermediate film 12 side thereof (i.e., a surface on the interior side of the vehicle) and including a terminal joint portion 20T to which the terminal 102 is joined; and the terminal 102 joined to the terminal joint portion 20T of the conductor 20 through lead-free solder 101.

In the example shown in the drawings, the laminated glass 10 is a laminated glass in which the first glass plate 11 and the glass plate with the terminal 13X are bonded together with the intermediate film 12 interposed therebetween.

In this embodiment, the first glass plate 11 is an exterior-side glass, and the glass plate with the terminal 13X is an interior-side glass.

As shown in FIG. 1A, the windshield for vehicle 1 includes an optical apparatus mounting region OP on which an optical apparatus is mounted, and a light-transmitting portion TP which is located inside the optical apparatus mounting region OP and through which external incident light entering the optical apparatus and/or outgoing light exiting from the optical apparatus passes.

As shown in the drawing, it is possible to form the light-transmitting portion TP in a region relatively close to one edge 10E (the upper edge in the example shown in the drawing) of the windshield for vehicle 1.

The optical apparatus can include, for example, an optical device that acquires information about an area ahead of a vehicle, such as an ADAS (Advanced Driver Assistance systems) camera, LiDAR (Light Detection And Ranging), a radar, and an optical sensor, and a housing referred to as a bracket or the like that houses the optical apparatus in order to perform automatic driving and/or to prevent a collision.

The shapes of the optical apparatus mounting region OP and the light-transmitting portion TP can be designed as appropriate according to the shape of the optical apparatus, and examples of shapes include roughly-trapezoidal shapes or roughly-rectangular shapes. The shapes of the optical apparatus mounting region OP and the light-transmitting portion TP can be similar to each other or dissimilar from each other. In the example shown in the drawing, both the optical apparatus mounting region OP and the light-transmitting portion TP have roughly trapezoidal shapes.

As shown in FIGS. 1A and 5, a second light-shielding layer BL2 is formed in a predetermined region on the surface S4 of the second glass plate 13 on the side thereof opposite to the intermediate film 12 side thereof (the surface on the interior side of the vehicle).

As shown in FIG. 1A, the forming region of the second light-shielding layer BL2 can include the part of the optical apparatus mounting region OP other than the light-transmitting portion TP, the region around the optical apparatus mounting region OP, and the peripheral region of the windshield for vehicle 1.

In the example shown in the drawing, the forming region of the second light-shielding layer BL2 includes the part of the optical apparatus mounting region OP other than the light-transmitting portion TP, the region around the optical apparatus mounting region OP, the region R21 which is the part of the roughly trapezoidal region outlined by one edge 10E (the upper edge in the example shown in the drawing) of the laminated glass 10 and sides B21 to B23 thereof other than the light-transmitting portion TP, and the peripheral region R22 of the windshield for vehicle 1.

In the example shown in the drawing, the second light-shielding layer BL2 surrounds all the four sides of the light-transmitting portion TP. However, the second light-shielding layer BL2 needs to surround only at least a part of the light-transmitting portion TP. For example, the second light-shielding layer BL2 may only surround three sides of the light-transmitting portion TP having a roughly trapezoidal shape or a roughly rectangular shape.

The wavelength range of light that passes through the light-transmitting portion TP is not limited to any particular wavelength ranges, and examples of the wavelength range include a visible light range, an infrared light range, and a range extending from the visible light range to the infrared light range.

As shown in FIGS. 1B and 5, if necessary, a first light-shielding layer BL1 can be formed on a predetermined region on the surface S2 of the first glass plate 11 on the intermediate film 12 side thereof (the surface on the interior side of the vehicle, i.e., the surface opposed to the second glass plate 13).

As shown in FIG. 1B, similarly to the second light-shielding layer BL2, the forming region of the first light-shielding layer BL1 can include the part of the optical apparatus mounting region OP other than the light-transmitting portion TP, the region around the optical apparatus mounting region OP, and the peripheral region of the windshield for vehicle 1.

In the example shown in the drawing, similarly to the second light-shielding layer BL2, the forming region of the first light-shielding layer BL1 includes the part of the optical apparatus mounting region OP other than the light-transmitting portion TP, the region around the optical apparatus mounting region OP, the region R11 which is the part of the roughly trapezoidal region outlined by one edge 10E (the upper edge in the example shown in the drawing) of the laminated glass 10 and sides B11 to B13 thereof other than the light-transmitting portion TP, and the peripheral region R12 of the windshield for vehicle 1.

Note that the planar shape of the region R11 of the first light-shielding layer BL1 and the planar shape of the region R21 of the second light-shielding layer BL2 may be designed independently of each other, and the planar shapes of these regions may be identical to each other or different from each other. For example, the planar shape of the region R11 of the first light-shielding layer BL1 may be designed so as to be wider than the region R21 of the second light-shielding layer BL2.

Similarly, the planar shape of the region R12 of the first light-shielding layer BL1 and the planar shape of the region R22 of the second light-shielding layer BL2 may be designed independently of each other, and the planar shapes of these regions may be identical to each other or different from each other.

As shown in FIG. 2, in this embodiment, the conductor 20 includes an electric function portion composed of an electric heating line 20L formed inside the light-transmitting portion TP. The conductor 20 further includes a feeding portion composed of a pair of feeding electrodes (a pair of busbars) 20B formed outside the light-transmitting portion TP. The conductor 20 further includes two connection lines 20M formed outside the light-transmitting portion TP and connecting the electric heating line 20L to the pair of feeding electrodes (the pair of busbars) 20B, respectively.

It is possible to improve the accuracy of the sensing of the optical apparatus by providing the electric heating line 20L for preventing condensation and frost from being formed in the region including the light-transmitting portion TP located in front of the optical device such as a camera and a radar included in the optical apparatus.

The number of electric heating lines 20L, the number of connection lines 20M, the number of feeding electrodes 20B, the line pattern and arrangement pattern of the electric heating lines 20L and the connection lines 20M, the shapes and arrangement pattern of the feeding electrodes 20B, and the like can be designed as desired.

For example, it is preferred that the electric heating line 20L be, in a plan view, repeatedly folded back so as to pass through the light-transmitting portion TP a plurality of times because, by this configuration, frost and water droplets formed in the light-transmitting portion TP can be efficiently removed.

The line width of the electric heating line 20L and/or the connection line 20M may be substantially uniform from one of the feeding electrodes to the other feeding electrode, or may be changed therebetween.

As shown in FIG. 5, in this embodiment, the conductor 20 is formed on the surface S4 of the glass plate with the terminal 13X on the side thereof opposite to the intermediate film 12 side thereof (the interior side of the vehicle).

The glass plate with the terminal 13X includes the second light-shielding layer BL2 between the second glass plate 13 and the feeding portion of the conductor 20 (the pair of feeding electrodes 20B). In other words, in the conductor 20, at least the feeding portion (the pair of feeding electrodes 20B) is formed on the second light-shielding layer BL2. The connection line 20M and the feeding portion (the pair of feeding electrodes 20B) are preferably formed on the second light-shielding layer BL2.

In the windshield for vehicle 1 according to this embodiment, it is possible to increase the breaking strength of the second glass plate 13 and the laminated glass 10 before the terminal is attached and to increase the second glass plate 13 and the laminated glass 10 after the terminal to attached by limiting the porosity of at least the forming region of the feeding portion in the second light-shielding layer BL2. The porosity of at least the forming region of the feeding portion in the second light-shielding layer BL2 is preferably 12% or lower, more preferably 10% or lower, still more preferably 8% or lower, still more preferably 5% or lower, particularly preferably 3% or lower, and most preferably 2% or lower.

Each of the pair of feeding electrodes (the pair of busbars) 20B includes the terminal joint portion 20T, and the terminal 102 is joined to the terminal joint portion 20T of the conductor 20 through the lead-free solder 101. A feeding member 103 composed of a round lead or foil lead is fixed to the terminal 102.

The terminal joint portion 20T of the conductor 20 is a part thereof located directly below the lead-free solder 101. In the drawings, the region of the terminal joint portion 20T is a region sandwiched between two broken lines T1 and T2. Note that the position of the terminal joint portion 20T of the conductor 20 is not clearly defined in advance. In the feeding electrode 20B, the part that is located directly below the lead-free solder 101 after the terminal 102 is joined thereto through the lead-free solder 101 is the terminal joint portion 20T.

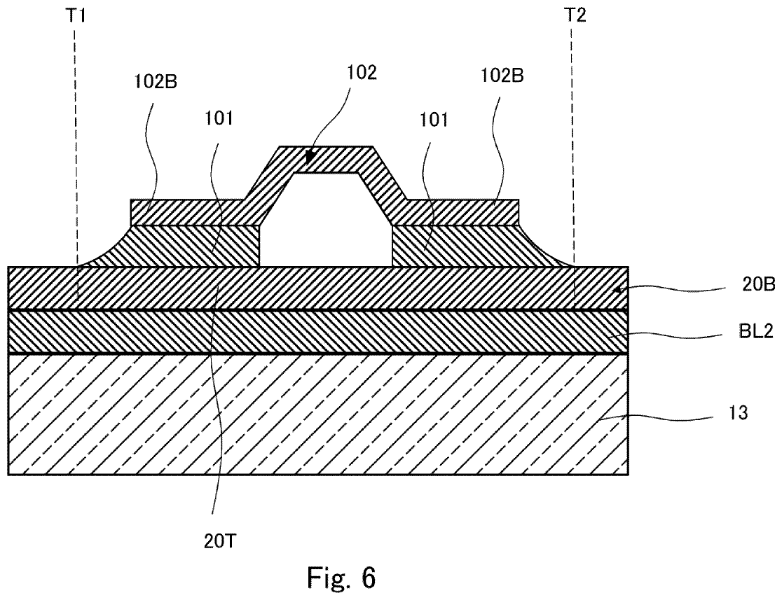

FIG. 6 is a partial enlarged cross-sectional diagram of the cross section of the laminated structure of Terminal 102/Lead-Free Solder 101/Feeding Electrode 20B/Second Light-Shielding Layer BL2/Second Glass Plate 13 shown in FIG. 5 as viewed from the left side in FIG. 5. In this example, the laminated structure is shown upside down for facilitating the visual recognition thereof.

As the feeding member 103, a round lead or foil lead is preferred, and a round coated lead or foil coated lead is more preferred. A wire harness, a flat harness, or the like is preferred.

The tip of the feeding member 103 is a conductor-exposed portion, and the terminal 102 is fixed to this conductor-exposed portion.

As the terminal 102, a known crimp terminal (e.g., a crimp contact) is preferred. The crimp terminal is preferably one that includes a feeding member joint portion 102A that comes into contact with the tip (the conductor-exposed portion) of the feeding member 103 (see FIG. 5) and a solder joint portion 102B that comes into contact with the lead-free solder 101 (see FIGS. 5 and 6).

When a wire harness is used as the feeding member 103, the crimp terminal is preferably one composed of, for example, a cylindrical feeding member joint portion 102A for swaging and fixing the tip (the conductor-exposed portion) of the wire harness, and a bridge-like portion including a solder joint portion 102B at each of both ends thereof as shown in FIGS. 5 and 6. The crimp terminal may be one that includes one solder joint portion 102B without including a bridge-like portion.

The terminal 102 is preferably a terminal made of metal. The metal of which the terminal is made is not limited to any particular metals, and examples thereof include: metals such as copper, iron, chromium, and zinc; alloys containing at least one metallic element such as copper, iron, chromium, and zinc; and combinations thereof. Examples of alloys include brass. The terminal 102 may be one in which a surface treatment such as tin plating is performed on its surface in advance. At least a part of the terminal 102 may be coated with an insulating material. The thickness of the terminal 102 is not limited to any particular values, and is preferably 0.4 to 0.8 mm. In the case of the terminal 102 made of a single material, it can be manufactured, for example, by punching a metal plate (a pressing process using a die) and thereby obtaining a metal plate having a desired size, and bending it into a desired shape (a bending process).

For example, the terminal 102 (preferably a crimp terminal) is swaged and fixed to the tip (the conductor-exposed portion) of the feeding member 103, and this terminal 102 is joined to the terminal joint portion 20T included in the feeding electrode 20B through lead-free solder 101. Note that the tip (the conductor-exposed portion) of the feeding member 103 and the terminal 102 may be connected by soldering or by welding.

As shown in FIGS. 1A, 1B, 2 and 3, in this embodiment, the first light-shielding layer BL1 and the second light-shielding layer BL2 are not formed inside the light-transmitting portion TP.

In the conductor 20, the electric heating line 20L is designed so as to be narrow so that it is less likely to be visually recognized by people outside the vehicle and does not affect the acquisition of information about an area ahead of the vehicle by the optical apparatus through the light-transmitting portion TP.

Since the feeding portion (the pair of feeding electrodes 20B) is formed on the second light-shielding layer BL2, it is not visible to people outside the vehicle.

The connection line 20M is preferably formed on the second light-shielding layer BL2 and can be designed so as not to be visible to people outside the vehicle.

The housing of an optical apparatus can be attached to the glass plate with the terminal 13X by using a material containing at least one type of adhesive, preferably a combination of an adhesive and double-sided tape.

Examples of adhesives include epoxy adhesives, urethane adhesives, silicone adhesives, modified silicone adhesives, melamine adhesives, phenolic adhesives, acrylic adhesives, and combinations thereof. The adhesives may be a one-component adhesive or a two-component adhesive. The adhesive is a one-component adhesive unless otherwise specified. Specific examples of adhesives include modified silicone-based adhesives, epoxy-based adhesives, two-component urethane-based adhesives, thermosetting urethane-based adhesives, and second-generation acrylic adhesives (SGA). In particular, urethane-based adhesives are preferred because of their stability and flexibility of adhesion to the housing of an optical apparatus.

In this embodiment, as shown in FIG. 2, in the glass plate with the terminal 13X, the outer periphery of the optical apparatus mounting region OP can be designed, in a plan view, so as to surround the light-transmitting portion TP and the conductor 20 for an optical apparatus.

### [Manufacturing Method]

A method for manufacturing a windshield for vehicle according to the present disclosure includes:
a step (X) of preparing a glass plate with a conductor in which a light-shielding layer and a conductor are formed on a surface of a second glass plate;
a step (Y) of bonding a first glass plate with the glass plate with the conductor with an intermediate film interposed therebetween; and
a step (Z) of joining a terminal to a terminal joint portion of the conductor through lead-free solder.

The step (X) may successively include:
a step (S11) of applying a ceramic paste containing a black pigment and glass frit, which are materials for the light-shielding layer, to the surface of the second glass plate, and thereby forming a ceramic paste layer thereon;
a step (S12) of applying a silver-containing paste containing silver and glass frit, which are materials for the conductor, to the surface of the second glass plate, and thereby forming a silver-containing paste layer thereon; and
a step (S13) of firing the ceramic paste layer and the silver-containing paste layer, and thereby forming the light-shielding layer and the conductor, respectively.

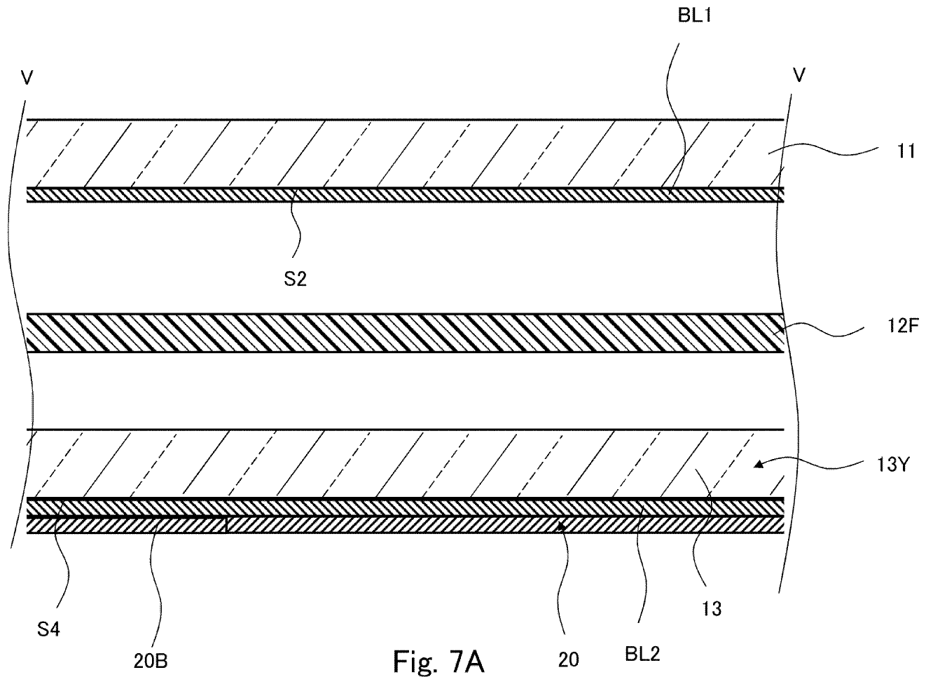

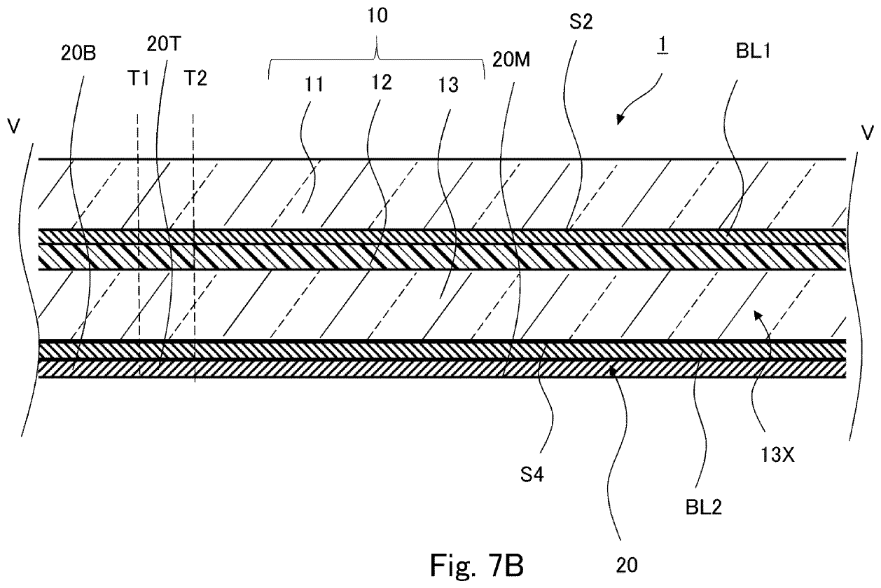

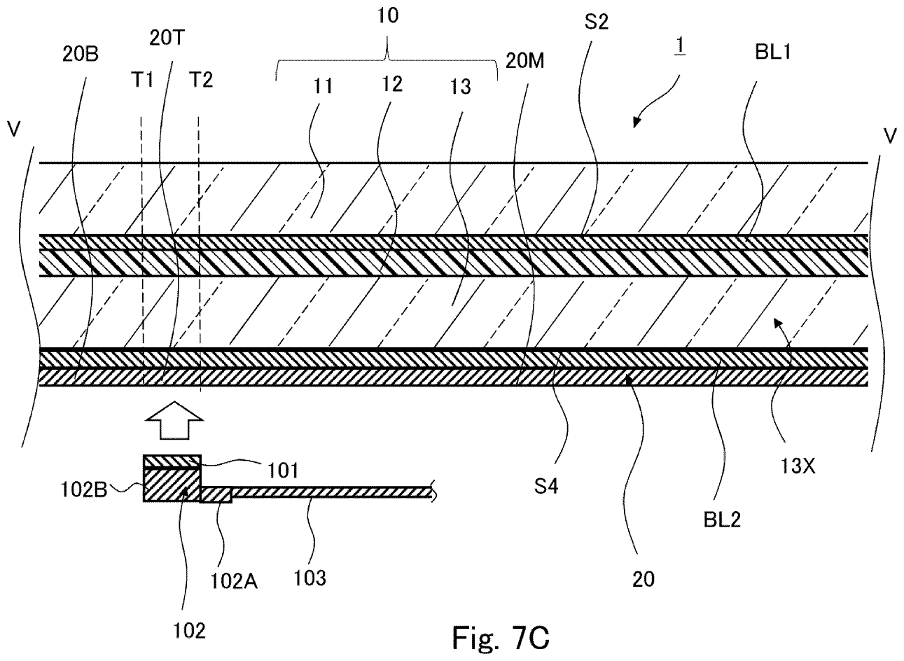

An example of the above-described method for manufacturing a windshield for vehicle according to the embodiment will be described hereinafter with reference to the drawings. FIGS. 7A to 7C are schematic cross-sectional diagrams corresponding to FIG. 5.

### (Step (X))

### <Step (S11)>

Firstly, a ceramic paste layer is formed by applying a ceramic paste containing a black pigment and glass frit, which are materials for a light-shielding layer, to a predetermined region on a surface S4 of a second glass plate 13, and drying the applied ceramic paste. If necessary, a ceramic paste layer may also be formed in a predetermined region on a surface S2 of a first glass plate 11 in a similar manner. The conditions for drying the ceramic paste can be designed as appropriate according to the composition of the paste, and are preferably, for example, 120 to 150° C. and about five minutes.

### <Step (S12)>

Next, a silver-containing paste layer is formed by applying a silver-containing paste containing a silver powder and glass frit to a predetermined region on the surface S4 of the second glass plate 13, on which the ceramic paste layer has been formed, and drying the applied silver-containing paste. The conditions for drying the silver-containing paste can be designed as appropriate according to the composition of the paste, and are preferably, for example, 120 to 150° C. and about five minutes.

### <Step (S13)>

Next, the second glass plate 13 is heated to a temperature equal to or higher than its softening point, and then bent into a desired shape. In this step, the ceramic paste layer and the silver-containing paste layer are simultaneously fired, so that a second light-shielding layer BL2 and a conductor 20 are formed. The first glass plate 11 is also bent into a desired shape in a similar manner. The ceramic paste layer, which has been formed on the first glass plate 11 as required, is fired in this step and becomes a first light-shielding layer BL1. After the firing, each of the glass plates is slowly cooled.

Through these steps, as shown in FIG. 7A, a first glass plate 11, which includes the first light-shielding layer BL1 as required, and a glass plate with a conductor 13Y, which includes the second light-shielding layer BL2 and the conductor 20 formed on the one surface S4 of the second glass plate 13, are obtained.

The ceramic paste layer and the silver-containing paste layer do not necessarily have to be simultaneously fired. The second light-shielding layer BL2 may be first formed by applying a ceramic paste to the surface S4 of the second glass plate 13, and drying and firing the applied ceramic paste, and then the conductor 20 may be formed by applying a silver-containing paste to the formed second light-shielding layer BL2, and drying and firing the applied silver-containing paste.

In this case, the step (X) successively includes:
a step (S21) of forming a light-shielding layer by applying a ceramic paste containing a black pigment and glass frit to the surface of the second glass plate, and firing the applied ceramic paste; and
a step (S22) of forming a conductor including a terminal joint portion by applying a silver-containing paste containing silver and glass frit to the surface of the second glass plate, and firing the applied silver-containing paste.

In this method, since the ceramic paste layer is fired before the silver-containing paste is applied, organic components in the ceramic paste layer easily come out therefrom, so that the porosity of the second light-shielding layer BL2 can be effectively reduced.

### (Step (Y))

Next, as shown in FIG. 7A, the first glass plate 11, which includes the first light-shielding layer BL1 as required, and the glass plate with a conductor 13Y are bonded together with a resin film 12F made of a material for an intermediate film 12 interposed therebetween by a known method.

The resin of which the resin film 12F is formed is not limited to any particular resins, and is preferably at least one resin selected from the group consisting of, for example, polyvinyl butyral (PVB), ethylene vinyl acetate copolymer (EVA), cycloolefin polymer (COP), polyurethane (PU), and ionomer resins. If necessary, the resin film 12F may contain at least one additive other than the resin. Examples of additives include colorants such as pigments. The resin film 12F may be transparent and colorless, or may be transparent and colored. The resin film 12F may have a single layer structure or a laminated structure composed of two or more layers.

The bonding can be carried out by thermocompression bonding. Examples of thermocompression bonding methods include: a method in which a temporary laminate obtained by stacking a plurality of members shown in FIG. 7A is put in a bag made of rubber or the like and heated in a vacuum; a method in which a temporary laminate is pressurized and heated by using an automatic pressurizing and heating apparatus and an autoclave or the like; and a combination thereof. The conditions for the thermocompression bonding, such as a temperature, a pressure, and a time, are not limited to any particular conditions and are designed according to the type of the resin film 12F and the temperature.

The conditions for the thermocompression bonding may be any conditions as long as the resin film 12F can be softened and sufficiently pressurized, and the first glass plate 11 and the glass plate with a conductor 13Y are sufficiently bonded to each other with a resin interposed therebetween. The thermocompression bonding may be carried out through a plurality of stages while changing the method or the conditions.

Note that the resin of which the resin film 12F is formed softens and spreads so as to fill the space between the first glass plate 11 and the glass plate with a conductor 13Y.

Through these steps, the laminated glass 10 shown in FIG. 7B is obtained.

### (Step (Z))

Next, as shown in FIG. 7C, a terminal(s) 102 is joined to the terminal joint portion 20T included in each feeding electrode 20B through lead-free solder 101. A feeding member 103, which is preferably composed of a round conductor or foil conductor, is fixed (preferably swaged and fixed) to the terminal 102 in advance by a known method. The solder joining is also shown in FIG. 6.

The solder joining can be performed by a known method, preferably by a method using a soldering iron or resistance heating.

When a soldering iron is used, the joining can be carried out, for example, as described hereinafter.

An appropriate amount (e.g., 0.05 to 0.10 g) of lead-free solder is applied to each solder joint portion of the terminal. This terminal is disposed on the terminal joint portion of the conductor. In this state, the tip of the soldering iron, of which the temperature is set to a temperature equal to or higher than the melting point of the lead-free solder, is pressed against the solder joint portion of the terminal, so that the lead-free solder is heated and melted. After that, the soldering iron is released from the terminal, and lead-free solder is solidified through natural cooling.

It is preferred that before the solder joining, a flux is applied to the surface of the lead-free solder that has not been melted yet and/or the surface of the solder joint portion of the terminal. The metal oxide film is melted by the effect of the flux, so that a satisfactory joint state can be achieved.

It is preferred that an appropriate amount of lead-free solder is put on the tip of the soldering iron and thereby is melted by the heat before the solder joining is performed. This solder is referred to as preparatory solder and can improve the heat conduction when the solder joining is performed.

In general, in order to join a conductor and solder in a satisfactory manner, it is necessary to form, at the joint interface between the conductor and the solder, an alloy layer containing an alloy of at least one metal element contained in the conductor and a plurality of metal elements contained in the solder. Therefore, the solder joining is performed by heating the solder to a temperature equal to or higher than its melting point.

The melting point of lead-free solder such as SnAg-based solder and SnAgCu-based solder is, for example, about 220° C. In this case, the temperature of the solder joining is, for example, about 300° C.

Through the above-described processes, a windshield for vehicle 1 according to this embodiment is manufactured.

As described above, according to the present disclosure, it is possible to provide a windshield for vehicle which includes a part in which a conductor is joined with a terminal by using lead-free solder, and can be designed so that a feeding portion of the conductor is not visible to people outside the vehicle, and in which a glass plate thereof to which the terminal has been attached has an improved breaking strength.

### EXAMPLES

The present disclosure will be described hereinafter based on examples, but the present disclosure is not limited to these examples. Examples 1 and 11-13 are examples according to the present disclosure.

### [Evaluation Items and Evaluation Method]

The evaluation items and the evaluation method are as follows.

### (Porosity)

A cross section of a glass laminate 1 for evaluation (Laminated structure: Conductor/Light-Shielding Layer/Glass Plate (to which no terminal had been attached yet)) was observed. The observation point was a part in the laminated structure of Conductor/Light-Shielding Layer/Glass Plate. When necessary, the glass laminate was cut in the thickness direction by using a high-speed diamond wheel saw (“Mecatome T180” manufactured by PRESI) and ground by using an automatic grinding machine (“Mecatech 234” made by PRESI). Further, when necessary, it was subjected to an ion milling process by using “ArBlade 5000” manufactured by Hitachi High-Tech Corporation.

Images of three randomly selected points on the cut surface, magnified by 2,500 times were acquired under a condition of a voltage of 3 kV by using a field emission scanning electron microscope (FE-SEM, “Regulus 8220” manufactured by Hitachi High-Tech Corporation). A plurality of large and small voids having various sizes were observed inside the light-shielding layer. In the cross-sectional SEM images, the voids were visible in black or gray. When necessary, voids of relatively light-colored gray were painted out in black through image processing. The image processing was performed by using commercially-available image analysis software (“WinRoo F2018” available from MITANI Corporation), and the ratio of the cross-sectional region of the black region corresponding to the voids to the total cross-sectional region of the light-shielding layer was defined as the porosity of the light-shielding layer. The average value of the porosities of three cross-sectional SEM images was obtained and used as data of the porosity (%).

### (Breaking Strength)

Ring bending tests were carried out in accordance with ASTM-C1499-1 by using an autograph (“AGS-X” manufactured by Shimadzu Corporation, Maximum load: 5 kN) under an environment of a normal temperature (20 to 25° C.).

The glass laminate 1 for evaluation (Laminated structure: Conductor/Light-Shielding Layer/Glass Plate (to which no terminal had been attached yet)) was placed on a support ring having a diameter of 98 mm with its surface on which the conductor was formed facing downward. A load ring having a diameter of 46 mm was placed on this glass laminate for evaluation. The central axes of the support ring, the glass plate, and the load ring are aligned with each other.

A load was applied to the periphery of the conductor of the above-described glass laminate for evaluation by the load ring. The load was continuously increased so that the displacement of the glass plate became 1 mm/min, and the load at the time when the glass plate was broken was defined as its breaking strength.

For each condition, a total of 15 to 20 samples were measured, and their maximum, minimum, or average value (also called an average breaking strength) was obtained. The average breaking strength was used as data of the breaking strength unless otherwise specified.

[Method for Manufacturing Glass Laminate 1 for Evaluation (Laminated structure: Conductor/Light-Shielding Layer/Glass Plate (to which no terminal had been attached yet))]

An un-tempered glass plate having a shape of 100 mm×100 mm square and a thickness of 3.5 mm (“VFL” manufactured by AGC Inc., green) was prepared. A ceramic paste layer was formed by applying a ceramic paste for forming a light-shielding layer, containing a black pigment and glass frit to one of the surfaces of this glass plate by a screen-printing method and drying the applied ceramic paste. The drying conditions were 120° C. and 15 minutes.

Next, a conductive paste layer was formed by applying a silver-containing paste for forming a conductor, containing a silver powder and glass frit to the above-described ceramic paste layer by a screen-printing method and drying the applied silver-containing paste. The drying conditions were 120° C. and 10 minutes.

Then, the ceramic paste layer and the conductive paste layer were fired. They were heated from a normal temperature (20 to 25° C.) to 600° C. or 640° C. at a temperature rising rate of about 2° C. per second, fired at this temperature (600° C. or 640° C.) for 400 seconds, and then naturally cooled to a normal temperature (20 to 25° C.). Through the above-described processes, a light-shielding layer and a conductor were formed.

The planar shape of the light-shielding layer was a 90 mm×90 mm square, and its center and diagonal line were aligned with the center and diagonal line, respectively, of the glass plate. The thickness of the conductor was about 15 μm.

The planar shape of the conductor was a 30 mm×30 mm square, and its center and diagonal line were aligned with the center and diagonal line, respectively, of the glass plate. The thickness of the conductor was about 7 μm.

Through the above-described processes, a glass laminate for evaluation 1 having a laminated structure of Conductor/Light-Shielding Layer/Glass Plate (to which no terminal had been attached yet) was manufactured.

### Examples 1 to 3

In each of Examples 1 to 3, a glass laminate 1 for evaluation (Laminated structure: Conductor/Light-Shielding Layer/Glass Plate (to which no terminal had been attached yet)) was manufactured by using the same commercially-available silver-containing paste (AgP1) while changing the condition in regard to the type (composition) of the ceramic paste and/or the firing temperature, and then evaluated.

In Example 1, a commercially-available ceramic paste (BP1) was used as the ceramic paste, and the firing temperature was 600° C.

In Example 2, a ceramic paste (BP2) that was obtained by adding 4 mass % of cross-linked acrylic resin particles (AR1) (“Cross-linked acrylic monodisperse particles MX-1000” manufactured by Soken Chemical Asia Co., Ltd., Average particle size: 10 μm) to the ceramic paste (BP1) was used as the ceramic paste, and the firing temperature was 600° C.

In Example 3, a ceramic paste (BP3) that was obtained by adding 2 mass % of cross-linked acrylic resin particles (AR1) to the ceramic paste (BP1) was used as the ceramic paste, and the firing temperature was 640° C.

The total content of organic components in each of the ceramic pastes (BP1) to (BP3) was 30 mass % or less, and the total content of polymers therein was 5 mass % or less.

Conditions that are not mentioned in this specification were the same as each other in these examples.

### Summary of Results of Examples 1 to 3

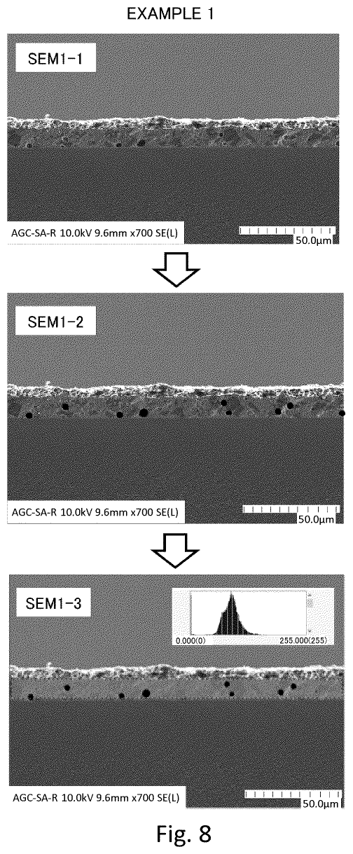

An example of measurement of a porosity is shown in FIGS. 8 to 10. An image at the top of FIG. 8 is an example of a cross-sectional SEM image (cross-sectional SEM image (SEM 1-1)) of the glass laminate 1 for evaluation obtained in Example 1.

An image at the middle of FIG. 8 is a cross-sectional SEM image (SEM 1-2) that was obtained by paining out gray holes by black in the aforementioned cross-sectional SEM image (SEM 1-1) through image processing.

An image at the bottom of FIG. 8 is an image (SEM 1-3) showing measurement data in regard to the porosity, obtained by performing an image analysis on the cross-sectional SEM image (SEM 1-2) by using image analysis software.

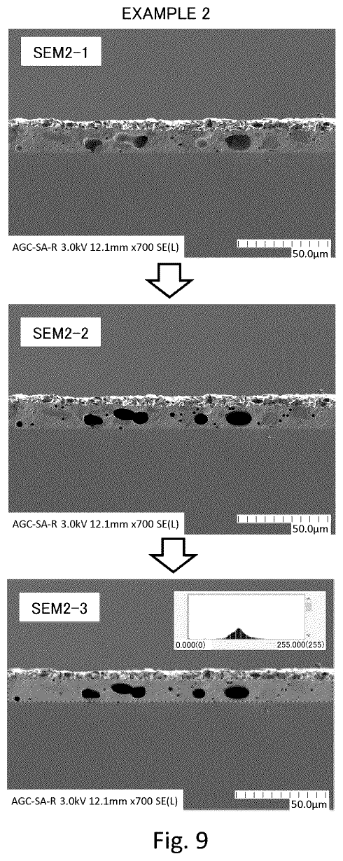

An image at the top of FIG. 9 is an example of a cross-sectional SEM image (cross-sectional SEM image (SEM 2-1)) of the glass laminate 1 for evaluation obtained in Example 2.

An image at the middle of FIG. 9 is a cross-sectional SEM image (SEM 2-2) that was obtained by paining out gray holes by black in the aforementioned cross-sectional SEM image (SEM 2-1) through image processing.

An image at the bottom of FIG. 9 is an image (SEM 2-3) showing measurement data in regard to the porosity, obtained by performing an image analysis on the cross-sectional SEM image (SEM 2-2) by using image analysis software.

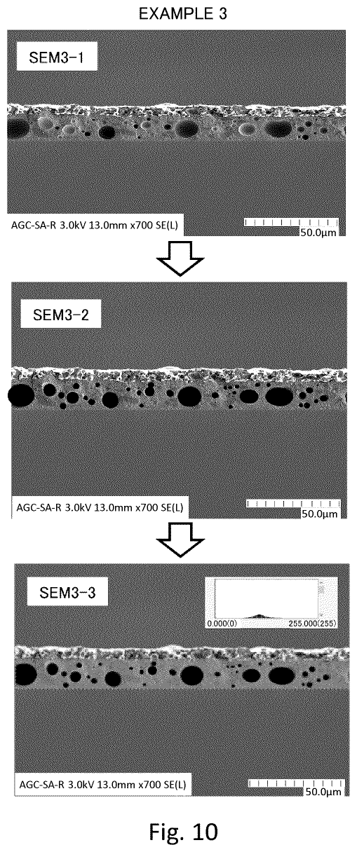

An image at the top of FIG. 10 is an example of a cross-sectional SEM image (cross-sectional SEM image (SEM 3-1)) of the glass laminate 1 for evaluation obtained in Example 3.

An image at the middle of FIG. 10 is a cross-sectional SEM image (SEM 3-2) that was obtained by paining out gray holes by black in the aforementioned cross-sectional SEM image (SEM 3-1) through image processing.

An image at the bottom of FIG. 10 is an image (SEM 3-3) showing measurement data in regard to the porosity, obtained by performing an image analysis on the cross-sectional SEM image (SEM 3-2) by using image analysis software.

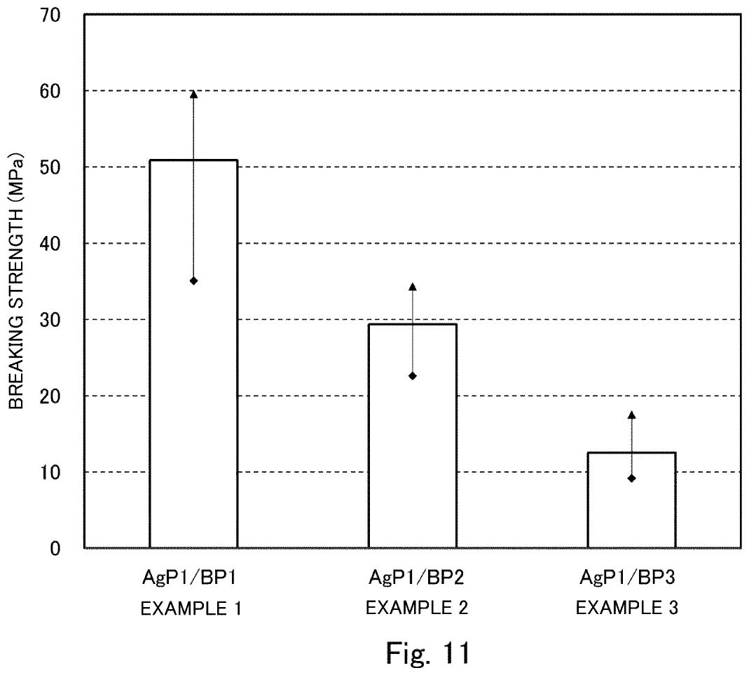

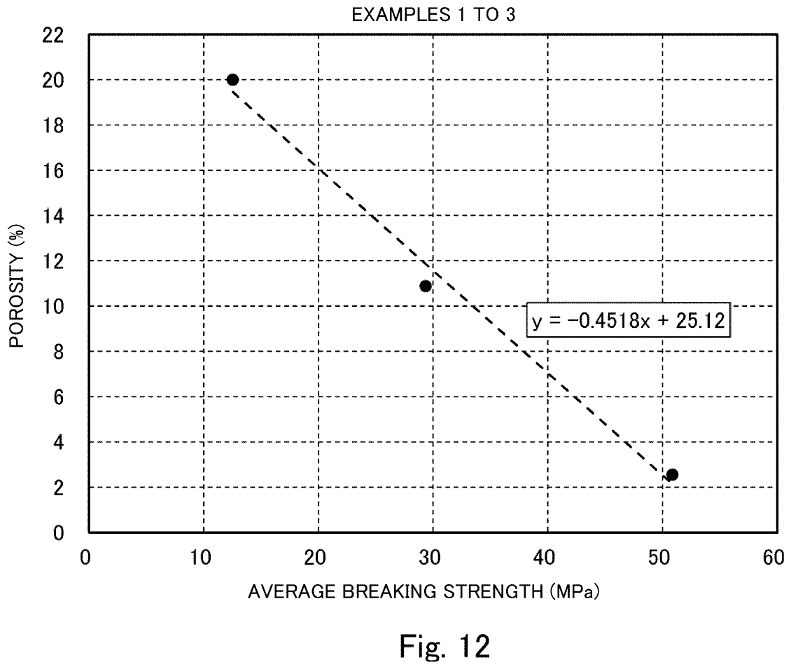

Table 1 shows principal manufacturing conditions and evaluation results (data on the porosity and the breaking strength) of the glass laminates obtained in Examples 1 to 3. FIGS. 11 and 12 show evaluation results (data on the porosity and the breaking strength) of the glass laminates obtained in Examples 1 to 3.

As shown in FIGS. 8 to 10, as compared with Example 1, voids having larger sizes were observed in Examples 2 and 3, in each of which resin particles were added to the ceramic paste. As compared with Example 1, a larger number of voids were observed in Examples 2 and 3, in each of which resin particles were added to the ceramic paste.

Provided that the condition in regard to the firing temperature was the same, the higher the amount of polymer components in the ceramic paste was, the higher the porosity of the light-shielding layer became. Further, when a polymer component(s) was added to the ceramic paste, the higher the firing temperature was, the higher the porosity of the light-shielding layer became. Note that when the ceramic paste (BP2), which was obtained by adding 4 mass % of cross-linked acrylic resin particles (AR1) to the ceramic paste (BP1), was used, and the firing temperature was 640° C., too much bubbles were generated, so that cracks were formed in the glass laminate during the firing.

As shown in Table 1, and FIGS. 11 and 12, the higher the porosity of the light-shielding layer was, the more the breaking strength of the glass plate tended to decrease.

As shown in FIG. 12, data on the glass laminate obtained in each of Examples 1 to 3 was plotted in a graph in which the x-axis indicates the average breaking strength (MPa) and the y-axis indicates the porosity (%). Then, an approximate expression for the plotted data was obtained, and a relation y=0.4518x+25.12 was obtained.

### Example 11 to 13

In each of Example 11 to 13, a glass laminate 1 for evaluation (Laminated structure: Conductor/Light-Shielding Layer/Glass Plate (to which no terminal had been attached yet)) was manufactured in the same manner as in Example 1 except that the type (composition) of the ceramic paste was changed. Then, their breaking strengths were measured.

In Example 11, a commercially-available ceramic paste (BP11) was used as the ceramic paste. In Example 12, a commercially-available ceramic paste (BP12) was used as the ceramic paste. In Example 13, a commercially-available ceramic paste (BP13) was used as the ceramic paste. In each of the ceramic pastes (BP11) to (BP13), the total content of organic components was 30 mass % or less and the total content of polymers was 5 mass % or less.

Conditions that are not mentioned in this specification were the same as each other in these examples. Table 2 shows principal manufacturing conditions and evaluation results of the glass laminates obtained in Examples 11 to 13.

### Reference Examples R1 to R4

As Reference Example R1, average data of the average breaking strengths of the glass laminates obtained in Example 11 to 13 was obtained.

By substituting data of the breaking strengths of Examples 11 to 13 and those of Reference Example R1 in the above-shown approximate expression (y=0.4518x+25.12), the porosities of their light-shielding layers were thereby calculated. These data are shown in Table 2.

Regarding Reference Examples R2 to R4, 28.0 MPa, 29.0 MPa, or 30.0 MPa were substituted as breaking strength data in the above-shown approximate expression (y=0.4518x+25.12), and the porosities of their light-shielding layers were thereby calculated. These data are shown in Table 3.

TABLE 1

| | Ceramic Paste | | | | | | |
|---|---|---|---|---|---|---|---|
| | | Amount of | | | | | |
| | | Added Resin | | Porosity | | | |
| | | Particles | Firing | (%) | Breaking Strength (MPa) | | |
| | | (AR1) | Temperature | (Measured | Maximum | Average | Minimum |
| Example | Type | (mass %) | (° C.) | Value) | Value | Value | Value |
| 1 | BP1 | 0 | 600 | 2.6 | 35.1 | 50.9 | 59.5 |
| 2 | BP2 | 4 | 600 | 10.9 | 22.6 | 29.4 | 34.3 |
| 3 | BP3 | 2 | 640 | 20.0 | 9.2 | 12.5 | 17.5 |

TABLE 2

| | Ceramic Paste | | | | |
|---|---|---|---|---|---|
| | | Amount of | | | |
| | | Added | | | |
| | | Resin | Firing | Porosity | Average |
| | | Particles | Tem- | (%) | Breaking |
| | | (AR1) | perature | (Measured | Strength |
| Example | Type | (mass %) | (° C.) | Value) | (MPa) |
| 11 | BP11 | 0 | 600 | 6.6 | 41.1 |
| 12 | BP12 | 0 | 600 | 7.5 | 39.0 |
| 13 | BP13 | 0 | 600 | 8.0 | 37.9 |
| Reference | — | — | — | 7.3 | 39.3 |
| Example R1 | | | | | |
| (Average Data | | | | | |
| of Examples | | | | | |
| 11 to 13) | | | | | |

TABLE 3

| | | Breaking |
|---|---|---|
| | Porosity | Strength |
| | (%) | (MPa) |
| Reference | (Calculated | (Presumed |
| Example | Value) | Value) |
| R2 | 12.5 | 28.0 |
| R3 | 12.0 | 29.0 |
| R4 | 11.6 | 30.0 |

### Summary of Results of Examples 11 to 13 and Reference Examples R1 to R4

From the data shown in Table 3, it has been found that when the porosity of the light-shielding layer is 12% or lower, it is possible to increase the breaking strength of the glass laminate before the terminal is attached to a sufficiently high level, e.g., to 28 MPa or higher, 29 MPa or higher, or 30 MPa or higher.

The breaking strengths of all of the glass laminates to each of which the terminal(s) had not been attached yet, obtained in Examples 11 to 13 were 30 MPa or higher.

It is inferred that the porosities of the light-shielding layers of all of the glass laminates to each of which the terminal(s) had not been attached yet, obtained in these examples were 12% or lower.

The present disclosure is not limited to the above-described embodiments and examples, and the designs of them can be modified as appropriate as long as they do not deviate from the scope and spirit of the present disclosure.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A windshield for vehicle comprising a laminated glass in which a first glass plate and a second glass plate are bonded together with an intermediate film interposed therebetween, wherein
the laminated glass comprises a glass plate with a terminal comprising the second glass plate, a conductor, and the terminal, the conductor being formed on a surface of the second glass plate on a side thereof opposite to an intermediate film side thereof, and comprising a terminal joint portion to which the terminal is joined, and the terminal being joined to the terminal joint portion of the conductor through lead-free solder,
the conductor comprises an electric function portion or is electrically connected to an electric function portion,
the conductor comprises a feeding portion for feeding electricity to the electric function portion, and the feeding portion comprises the terminal joint portion,
the glass plate with the terminal comprises a light-shielding layer between the second glass plate and at least a part of the conductor comprising the feeding portion, and
a porosity of at least a forming region of the feeding portion in the light-shielding layer is 12% or lower.

2. The windshield for vehicle according to claim 1, wherein the porosity of at least the forming region of the feeding portion in the light-shielding layer is 8% or lower.

3. The windshield for vehicle according to claim 2, wherein the porosity of at least the forming region of the feeding portion in the light-shielding layer is 3% or lower.

4. The windshield for vehicle according to claim 1, wherein the light-shielding layer contains a black pigment and glass frit.

5. The windshield for vehicle according to claim 1, wherein the conductor contains silver and glass frit.

6. The windshield for vehicle according to claim 1, wherein
the glass plate with the terminal comprises, in a plan view, an optical apparatus mounting region and a light-transmitting portion, the optical apparatus mounting region being configured so that an optical apparatus is mounted therein, and the light-transmitting portion being located inside the optical apparatus mounting region and configured so that external incident light entering the optical apparatus and/or outgoing light exiting from the optical apparatus passes therethrough,
the light-shielding layer is formed, in the plan view, so as to surround at least a part of the light-transmitting portion, and
the conductor comprises an electric heating line formed inside the light-transmitting portion, the feeding portion formed outside the light-transmitting portion, and a connection line formed outside the light-transmitting portion and connecting the electric heating line with the feeding portion.

7. The windshield for vehicle according to claim 6, wherein the connection line and the feeding portion are formed on the light-shielding layer in the glass plate with the terminal.

8. The windshield for vehicle according to claim 1, wherein a feeding member formed of a round lead or a foil lead is fixed to the terminal.

9. A method for manufacturing a windshield for vehicle according to claim 1, comprising:
a step (X) of preparing a glass plate with a conductor in which the light-shielding layer and the conductor are formed on the surface of the second glass plate;
a step (Y) of bonding the first glass plate with the glass plate with the conductor with the intermediate film interposed therebetween; and
a step (Z) of joining the terminal to the terminal joint portion of the conductor through lead-free solder, wherein
the step (X) successively comprises:
a step (S11) of applying a ceramic paste containing a black pigment and glass frit to the surface of the second glass plate, and thereby forming a ceramic paste layer thereon, the black pigment and the glass frit being materials for the light-shielding layer;
a step (S12) of applying a silver-containing paste containing silver and glass frit to the surface of the second glass plate, and thereby forming a silver-containing paste layer thereon, the silver and the glass frit being materials for the conductor; and
a step (S13) of firing the ceramic paste layer and the silver-containing paste layer, and thereby forming the light-shielding layer and the conductor, respectively.

10. A method for manufacturing a windshield for vehicle according to claim 1, comprising:
a step (X) of preparing a glass plate with a conductor in which the light-shielding layer and the conductor are formed on the surface of the second glass plate;
a step (Y) of bonding the first glass plate with the glass plate with the conductor with the intermediate film interposed therebetween; and
a step (Z) of joining the terminal to the terminal joint portion of the conductor through lead-free solder, wherein
the step (X) successively comprises:
a step (S21) of forming the light-shielding layer by applying a ceramic paste containing a black pigment and glass frit to the surface of the second glass plate, and firing the applied ceramic paste; and
a step (S22) of forming the conductor by applying a silver-containing paste containing silver and glass frit to the surface of the second glass plate, and firing the applied silver-containing paste.

11. The method for manufacturing a windshield for vehicle according to claim 9, wherein a total content of organic components in the ceramic paste is 30 mass % or less.

12. The method for manufacturing a windshield for vehicle according to claim 9, wherein a total content of polymer components in the ceramic paste is 5 mass % or less.
